(19) United States
(12) Patent Application Publication
(10) Pub. No.: US 2017/0308966 A1
(43) Pub. Date: Oct. 26, 2017

(54) POST-EVALUATION AND RISK MANAGEMENT AND CONTROL METHOD OF POWER TRANSMISSION ENGINEERING COST

(71) Applicants: Economy Research Institute of State Grid Zhejiang Electric Power, Hangzhou Zhejiang (CN); State Grid Corporation of China, Bejing (CN)

(72) Inventors: Huajun SHI, Hangzhou Zhejiang (CN); Yingtu MAO, Hangzhou Zhejiang (CN); Min YU, Hangzhou Zhejiang (CN); Liang LINAG, Hangzhou Zhejiang (CN); Jun TONG, Hangzhou Zhejiang (CN); Fuyan LIU, Hangzhou Zhejiang (CN); Zhanghua CAI, Hangzhou Zhejiang (CN); Jia CHEN, Hangzhou Zhejiang (CN); Hui CHEN, Hangzhou Zhejiang (CN)

(21) Appl. No.: 15/492,460

(22) Filed: Apr. 20, 2017

(30) Foreign Application Priority Data
Apr. 22, 2016 (CN) 201610262139.2

(51) Int. Cl. G06Q 50/06; G06Q 30/02; G06Q 40/06

(52) U.S. Cl. CPC G06Q 50/06; G06Q 40/06; G06Q 30/0201; G06Q 30/0283

(57) ABSTRACT

A VAR-based post-evaluation and risk management and control method is disclosed herein. The power transmission engineering cost is broken down sub-item costs, and the stochastic behavior of sub-item costs is simulated by normal distribution, to determine the VaR of sub-item cost at a confidence, then the VaR and ratio of mean of sub-item costs are used as the weights of sub-item cost, to establish the post-evaluation model of sub-item cost, then according to the ratio of sub-item cost among total cost, a contribution degree index is established, and the main sub-item costs are screened according to the sequence of contribution degree index; then based on this, considering the constraint of risk rate interval and aiming at controlling the main sub-item cost within the allowable risk interval, a stochastic linear programming model is established; finally, Monte Carlo method is used to sample and simulate the random factors to solve the stochastic linear programming problem. The method provided herein can effectively perform evaluation on the risk of cost fluctuation, to achieve control over the cost within a risk interval.

### FIELD OF THE INVENTION

The present invention relates to a field of power system engineering cost management, in particular, to a post-evaluation and risk management and control method of power transmission engineering cost.

### BACKGROUND

Power transmission engineering is an important part of power network construction, and its amount of investment is usually large. There are many uncertainty factors in the power transmission engineering implementation process, such as design changes, schedule delays, equipment price change, etc. These uncertainty factors may cause fluctuation of power transmission engineering cost, resulting in cost and investment risks. Thus, it is necessary to consider the influence of uncertainty factors when evaluating the cost of the power transmission, analyze its possible risks, and study appropriate risk control measures, so as to predict and determine the costs in various stages of project reasonably, and thus control the total cost within a reasonable limit.

The total cost of power transmission engineering consists of a number of independent sub-item costs of unit project. Since it is complicated and difficult to analyze the effect of uncertainty factors on the total cost, and relatively simple to analyze the effect of sub-item cost, the evaluation and risk control on total cost can be converted to evaluation and risk control on sub-item costs. At present, usually the weight analysis method is used to evaluate the effect of different factors on power transmission engineering cost. Commonly-used methods include AHP (Analytic Hierarchy Process, AHP), principal component analysis and entropy weight method. These methods have the following drawbacks when used to evaluate the effect of each sub-item cost on total cost: usually AHP method requires expert knowledge and experiences, which is quite subjective; principal component analysis requires dimension reduction on various sub-item cost or factors, and the final principal component can not fully reflect the independent weight of single cost or single factor; entropy weight method is easily interfered by abnormal fluctuations, that is, when there are unreasonable data with great deviation in the samples, the results by weight calculation have great errors. Moreover, the three methods are unable to measure the risk interval of sub-item cost fluctuation.

So far, a variety of methods for risk measurement have been proposed, including Tail Conditional Expectation (Tail Conditional Expectation, TCE), VaR (Value at Risk, VaR) and Conditional Value at Risk (Conditional Value at Risk, CVaR), etc; TCE is similar to CVaR, and under a continuous distribution function, TCE is equivalent to CVaR. VaR is commonly used in the financial field, which means the maximum potential loss of a portfolio of investment products in a specific time period in the future under normal market conditions and a given confidence level. The definition of CVaR is the conditional mean that the loss exceeds VaR under a confidence level, which reflects the mean level of excess losses. Generally it is believed that tail loss measurement of VAR has non-sufficiency, while CVaR can reflect the potential risk of investment portfolio appropriately. Since the natural and market environment for power transmission engineering in the same region are the same, and some experiences have accumulated from historical engineering, when risk measurement of VaR and CVaR is used to actual power transmission engineering, its tail risk is usually caused by special reasons (such as major policy mistakes), which can be usually ignored; but if CVaR is used, which considers this tail risk, the actual risk is overstated.

### SUMMARY

The object of the invention is to overcome the above problems and provide a VAR-based post-evaluation and risk management and control method of power transmission engineering cost.

To achieve the object, the invention employs the following technical solutions:

A VAR-based post-evaluation and risk management and control method of power transmission engineering cost is provided. Through introducing the VAR theory into the evaluation and risk measurement of costs, a VAR-based post-evaluation and risk management and control method of power transmission engineering cost is proposed.

A VAR-based post-evaluation method of power transmission engineering cost, including:

(1) breaking down the power transmission engineering into a plurality of unit projects, including earthwork, foundation engineering, tower engineering, overhead line engineering and accessory engineering according to the contents of the power transmission engineering projects, namely five sub-item costs. Each unit project has a strong independence, to convert the evaluation of total cost into evaluation of sub-item costs, so as to have a detailed evaluation on the engineering cost, and identify the root cause of sub-item cost volatility based on the evaluation results.
(2) Calculating the weight of sub-item cost of each unit project based on VAR theory.

A weight evaluation model of unit project sub-item cost is established based on VaR theory.

The sub-item cost of the power transmission engineering is divided by unit project, when X represents unit project vector, vector YεR^{m} (R^{m} represents m-dimensional real number space) represents uncertainty factor, each sub-item cost can be expressed as f(X,Y). The probability distribution function of f(X,Y) is calculated as follows:

Assuming that the JPDF of Y is p(Y), the probability of f(X,Y) that does not exceed a given critical value α (α represents a given sub-item cost level) for a definite X is:

$$ϕ ( X , α ) = {\int }_{f ( X , Y ) \leq α} p ( Y ) dY \qquad ( 1 )$$

where, X=[X₁, X₂, . . . , Xₙ], n is the number of unit project; φ(X,α) is the distribution function of sub-item cost.

It is usually difficult to directly obtain the JPDF of random variables affecting the sub-item cost, and thus it is unable to get the distribution function of sub-item cost through the above formula (1). However, since the changes in sub-item cost caused by random factors have features of volatility clustering, it is generally simulated by normal distribution, namely, obtaining the distribution curve of φ(X,α) by direct simulation based on historical data.

The corresponding VaR value of each sub-item cost f(X,Y) is represented by α_{β}(X) when the confidence that f(X,Y) does not exceed the critical value α is β, then α_{β}(X) can be represented by the following formula (2):

α_{β}(X)=min{αεR:φ(X,α)≧β} (2)

u(X) represents the mean of sub-item costs in φ(X,α) distribution curve; under a given confidence, the greater the deviation of VaR of sub-item cost from the mean, the greater the risk of sub-item cost fluctuations, thus, the overall volatility weight of sub-item cost can be described by the mean of deviation of VaR under a given confidence. Assuming that Xᵢ represents an unit project, the mean of corresponding sub-item costs is represented by u(Xᵢ), the corresponding VaR value under the confidence β is represented by α_{β}(Xᵢ), assuming that θ_{β}(Xᵢ) represents weight, it can be represented by the ratio in the formula (3):

θ_{β}(Xᵢ)=α_{β}(Xᵢ)/u(Xᵢ) (3)

where, Xᵢ represents a unit project; i=1, 2, . . . , n, n is the number of unit project;

θ_{β}(Xᵢ)

θ_{β}(Xᵢ) can be used to qualitatively assess the risk of fluctuation of each unit project sub-item cost, thus it is required to focus on the unit project with greater weight in the management and control process.
(3) Establishing a post-evaluation method for cost fluctuation according to the weight of sub-item cost of each unit project.

Using the weight result under confidence β as a reference, the post-evaluation of the level of risk of sub-item cost for a specific power transmission engineering is performed, assuming that c(Xᵢ) represents a sub-item cost corresponding to a unit project Xi of a particular project; θ(Xᵢ) represents the degree of deviation from the population mean, i.e. deviation coefficient, which is measured according to the ratio in the formula (4).

θ(Xᵢ)=c(Xᵢ)/u(Xᵢ) (4)

Assuming that σ(Xᵢ) represents the risk assessment score of Sub-item cost c(Xᵢ), its value is measured by difference of overall volatility weight θ_{β}(Xᵢ) between θ(Xᵢ) and sub-item cost under confidence β, namely:

σ(Xᵢ)=θ(Xᵢ)−θ_{β}(Xᵢ) (5)

The smaller σ(Xᵢ) is, the smaller the risk of fluctuations of sub-item cost c(Xᵢ) for the particular project.

A VAR-based risk management and control method of power transmission engineering, including:

(1) The sub-item cost of each unit project is different, and its influence on total cost is different. Here, an index of contribution degree is proposed to measure the effect of sub-item cost of each unit project on total cost, and determine the unit project that should focus on management and control according to the sequence of contribution degree.

The contribution degree consists of two parts: (1) overall volatility level of all sub-item costs, i.e. the weight as stated above; (2) the proportion of each sub-item cost among total cost. Firstly, if only analysis of the ratio, for a sub-item cost with high ratio but less fluctuation, the sub-item cost can be approximated as a constant, and its influence on overall cost volatility is less; secondly, if only analysis of the volatility level, for a sub-item cost with great volatility but less ratio, its influence on overall cost volatility is less. By comprehensively considering the weight and ratio, the contribution degree index can be calculated by the following formula:

k(Xᵢ)=kₚ(Xᵢ)×θ_{β}(Xᵢ) (6)

Where, kₚ(Xᵢ) is the proportion of sub-item cost c(Xᵢ) among total cost; i=1, 2, . . . , n, n is the number of unit projects.

(2) Screening the main sub-item cost according to the sequence of contribution degree, establishing an optimized stochastic linear programming model of sub-item cost.

Unit projects with great contribution can be identified according to the sequence of contribution degree, so as to focus on their risk management and control.

Many factors will influence the cost, including voltage level, the number of loops, wind speed, icing and other technical factors; besides, many social factors such as project management level, equipment development level, inflation rate, etc. The program design is based on technical factors; after formation of a specific design program, the designs may be changed due to the design, construction and quality problems during implementing power transmission projects. The cost of design change risk can be expressed as the product of general cost level multiplied by the rate of design changes according to the formula (7):

c₁=γ₁×y₀ (7)

Where, γ₁ is the rate of design change risk, y₀ is the general cost level; γ₁ is random but its value should be within a range of [γ₁₋, γ₁₊], if exceeding the range, the engineering is feasible; γ₁₋ and γ₁₊ are determined by historical data or experiences. The design change cost under a given risk rate can be used to guide the formation and comparison of design change program.

Duration management risks exist during the implementation of power transmission engineering. The project implementation cost mainly consists of two parts: direct cost and indirect cost. The direct cost refers to the sum of direct costs of all processes for the power transmission engineering plan, which include the costs of raw materials, machinery and equipment and labors for the processes. The indirect cost mainly includes the costs for management, supervision, inspection and coordination during the engineering project implementation, which is correlated to the project duration. The longer the duration, the higher the indirect cost; for an actual project, an approximate indirect cost within a unit time can be given. By this way, the cost for the duration management risk can be expressed by the formula (8):

c₂=T×i_{c} (8)

where, T represents time exceeding the estimated duration, i_{c} is the rate of indirect cost within unit time, which can be estimated by experts or calculated from the indirect cost in the budget statement by the duration. Assuming that γ₂ represents the rate of duration management risk, γ₂=T/T₀, T₀ is the estimated duration, then the formula (8) can be expressed as:

c₂=γ₂×T₀×i_{c} (9)

The rate of duration management risk is random and varied, and its range of variation is limited by the longest duration. The range of values can be expressed as [γ₂₋, γ₂₊]. We can facilitate the scientific management of duration by calculating the duration management cost within a risk rate.

There are uncertainty factors of equipment price changes and labor cost changes in the span of construction duration. The two costs can be expressed by the formula (10):

c₃=c₃₁×γ₃₁+c₃₂×γ₃₂ (10)

Where, c31 represents the estimated cost of equipment, γ31 represents the rate of equipment price risk; c₃₂ represents the estimated cost of labor, γ₃₂ represents the rate of labor cost risk. γ₃₁ and γ₃₂ vary with the fluctuation of supply-demand relationship of equipments and labor markets. It can be believed that their value intervals can be predicted, represented by [γ₃₁₋, γ₃₁₊] and [γ₃₂₋, γ₃₂₊] respectively. The calculation of the equipments and labor costs within a given rate of risks can facilitate the procurement and employment negotiations, so as to control the cost within a reasonable risk interval.

Based on above work, a stochastic linear programming model can be established to control the cost within a reasonable range of risk:

y_{β-}≦(1+γ₁)×y₀+γ₂×T₀×ic+c₃₁×γ₃₁+c₃₂×γ₃₂≦y_{β+} (11)

γ₁₋≦γ₁≦γ₁₊ (12)

γ₂₋≦γ₂≦γ₂₊ (13)

γ₃₁₋≦γ₃₁≦γ₃₁₊ (14)

γ₃₂₋≦γ₃₂≦γ₃₂₊ (15)

Where, β is confidence, y_{β-} and y_{β+} represent the left boundary value and right boundary value of VaR at the confidence β; y₀ represents a general cost level under the design scheme; γ1, γ2, γ31 and γ32 represent the rate of design change risk, rate of duration management risk, rate of equipment price risk and rate of labor cost risk respectively; [γᵢ₋, γᵢ₊] represents the interval of γᵢ, i.e. the constraints of the optimization model.

Assuming that y=(1+γ)×y₀+γ₂×T₀× ic+c₃₁×γ₃₁+c₃₂× γ₃₂, the target of the above optimization problem is to control y within the interval [yβ−, yβ+], the solution of optimization model is the risk intervals of γ₁, γ₂, γ₃₁ and γ₃₂, and the above problem is converted to obtain the combination of optimal solutions of γ₁, γ₂, γ₃₁ and γ₃₂ when y is the right boundary y_{β+}; here, the combination of optimal solution refers to the maximum of combination (γ₁, γ₂, γ₃₁, γ₃₂), that is, as long as the risk is controlled within the range of optimal combination, it can ensure that y is within [y_{β-}, y_{β+}], namely:

max(γ₁,γ₂,γ₃₁,γ₃₂) (16)

(1+γ₁)×y₀+γ₂×T₀×ic+c₃₁×γ₃₁+c₃₂×γ₃₂=y_{β+} (17)

γ₁₋≦γ₁≦γ₁₊ (18)

γ₂₋≦γ₂≦γ₂₊ (19)

γ₃₁₋≦γ₃₁≦γ₃₁₊ (20)

γ₃₂₋≦γ₃₂≦γ₃₂₊ (21)

\textcircled{3} Random variables in the above optimization model are simulated using Monte Carlo method, to obtain a group of optimal solutions based on samples in each group, and for the combination of 50 groups of optimal solutions within the solution domain, their mean is used as the optimal solution.

The VAR-based post-evaluation method and risk management and control method of power transmission engineering cost provided in the invention can implement effective evaluation on the cost fluctuation risks; and through screening the key unit project by the contribution degree index, it can effectively reduce the risk control dimension, enhance risk management and control efficiency; and finally through establishing a stochastic programming model, it can achieve control over the cost within a risk interval.

### BRIEF DESCRIPTION OF THE DRAWINGS

FIG. 1 is a flow chart of post-evaluation and risk management and control method of power transmission engineering cost in the invention;

FIG. 2 is an exploded schematic view of power transmission engineering cost in the invention;

FIG. 3 is a schematic diagram of sub-item cost weights of power transmission engineering in the invention;

FIG. 4 is a schematic diagram of risk evaluation scores of sub-item costs of power transmission engineering in the invention;

FIG. 5 is a schematic diagram of contribution degree of sub-item costs of power transmission engineering in the invention;

FIG. 6 is a schematic diagram of risk rate values in the invention.

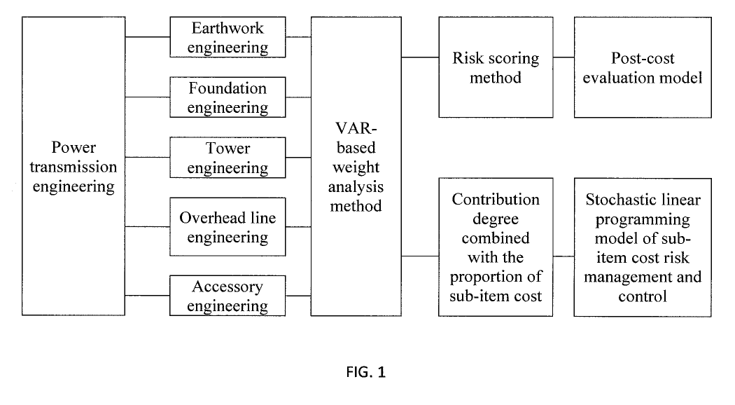

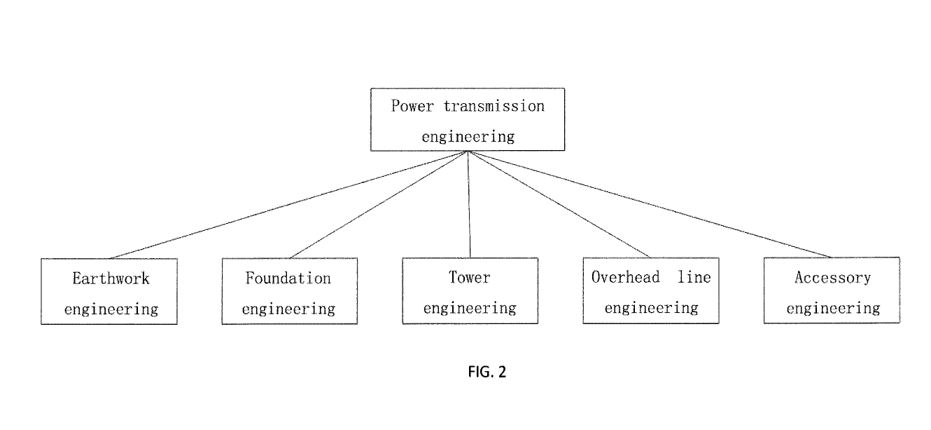

### DETAILED DESCRIPTION

The present invention is further described in combination with drawings and specific embodiments.

For the post-evaluation and risk management and control method of power transmission engineering cost, an engineering example in the same region is given to illustrate the effectiveness of the method.

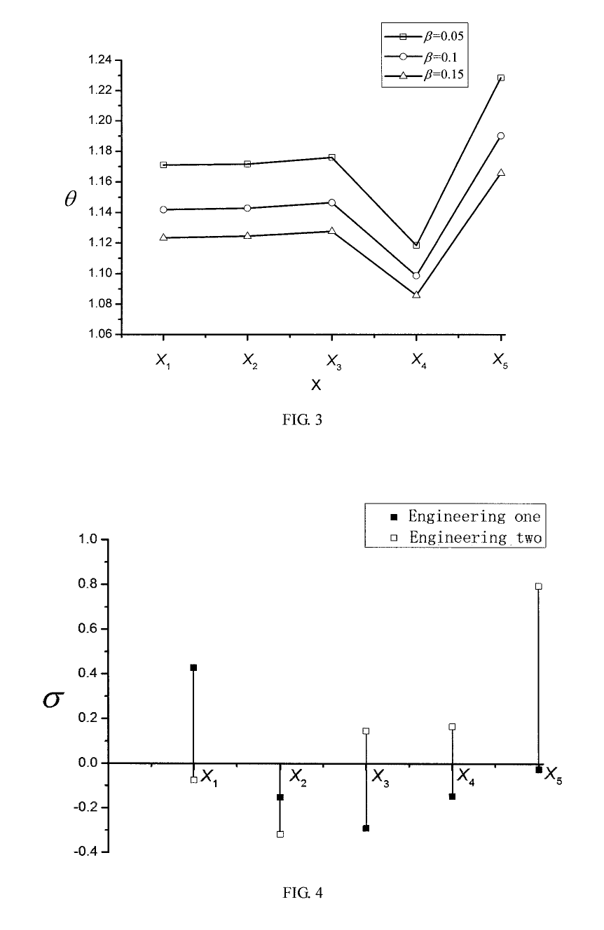

Forty groups of historical power transmission engineering data in a region are selected for analysis. Normal distribution is employed to simulate all sub-item cost data. Based on VaR theory, the weights of unit projects are calculated at confidence levels 0.05, 0.1 and 0.15. In FIG. 3, X₁˜X₅ represent the earthwork, foundation engineering, tower engineering, overhead line engineering and accessory engineering respectively.

As shown from FIG. 3, the weights show a same trend at three confidence levels, and the sequence of weight values is: accessory engineering>tower engineering>foundation engineering>earthwork>overhead line engineering, thus, during the cost management and control, it should firstly focus on the accessory engineering, foundation engineering and tower engineering.

The standard confidence of the risk is set at 0.1 and a post-evaluation on the sub-item costs of two specific projects is performed, as shown in FIG. 4. When the sub-item cost is equal to VaR under the standard confidence, the risk evaluation score is zero. In the project I, except for earthwork, the risk evaluation score of other four sub-item costs is less than zero, indicating that the volatility of sub-item cost is less than the cost volatility under the standard confidence. In the project II, the risk evaluation scores of earthwork and foundation engineering are both less than zero, indicating that the fluctuation of sub-item cost is less than the cost volatility under the standard confidence; while the risk evaluation scores of the other three sub-item costs are greater than the standard level, indicating that the volatility is great. According to the sub-item cost ratio, it can be calculated that the total risk scores of the project I and project II are −0.136 and 0.107 respectively. The total risk score of project I is less than zero, indicating that its overall cost fluctuation is less than the volatility under the standard confidence; the results of project II indicate that its overall cost fluctuation is higher than the volatility under the standard confidence and its level of risk is high. Therefore, the risk evaluation result of project I is superior to that of project II.

The contribution degree index of each sub-item can be calculated in combination with the weights and ratio of sub-item costs at the standard confidence, as shown in FIG. 5. The sequence of contribution degree is: tower engineering>foundation engineering>overhead line engineering>accessory engineering>earthwork. This sequence reflects that the tower engineering exerts greatest influence on the total cost in all unit projects of power transmission engineering, and the sum of contribution degree indexes of the tower engineering, foundation engineering and overhead line engineering accounts for more than 85%, reflecting the total cost on the whole. Thus, the three unit projects are the key objects for management and control.

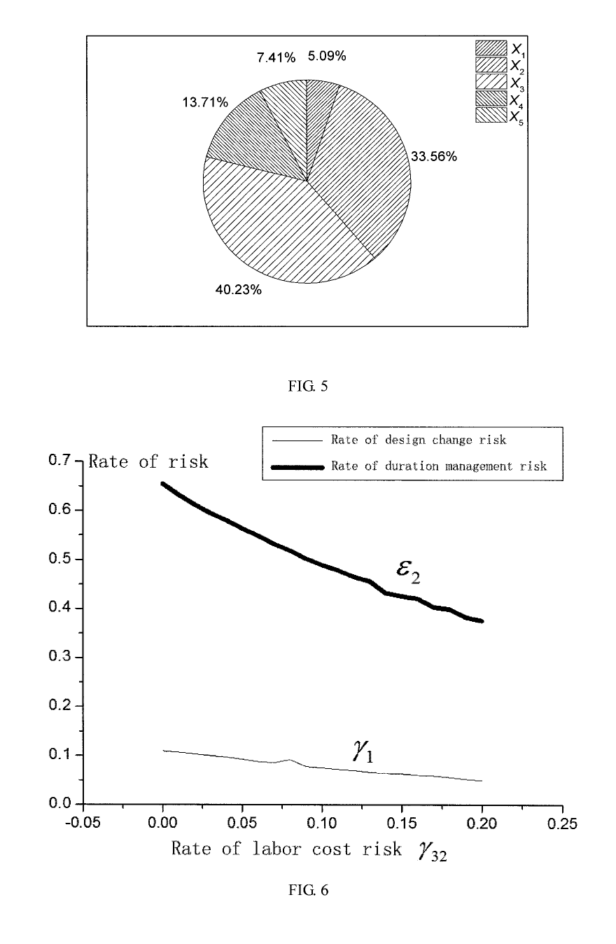

Taking tower engineering as an example, we perform calculation using the aforementioned optimization model. Due to diversity of common devices in the market, the overall price level of devices changes little. Assuming that γ₃₁=0 and given γ₃₂ ε[0, 0.2], we can calculate the certain linear optimization model to get the results as shown in FIG. 6 after sampling simulation using the Monte Carlo method. With the increase in γ₃₂, the values of γ₁ and γ₂ decrease slowly. When γ₃₂=0.1, the combination of optimal risk rates (γ₁, γ₂)=(0.064, 0.415). The results show that, when γ₃₁=0 and γ₃₂=0.1, the tower engineering cost can be controlled within the risk interval at the confidence level under the following case: 1) when γ₁ is controlled less than 0.064, that is, the design change cost is controlled within 6.4% of the budget costs; 2) γ2 is controlled less than 0.415, that is, the part exceeding the duration is controlled within 41.5% of the estimated duration. The results can be used for program design guidance, comparison and risk management and control in the construction process.

The specific embodiments described above, as preferred embodiments, are used to explain rather than limit the invention. Any modification, equivalent replacement and improvement made within the spirit and claims of the invention shall fall within the scope of protection of the present invention.

1. A post-evaluation method of power transmission engineering cost, comprising:
(1) breaking down the power transmission engineering into a plurality of unit projects according to the contents of the power transmission engineering projects;
(2) calculating the weight of sub-item cost of each unit project based on VAR theory;
(3) establishing a post-evaluation method for cost fluctuation according to the weight of sub-item cost of each unit project.

2. The post-evaluation method of power transmission engineering cost according to claim 1, wherein the unit project comprises earthwork, foundation engineering, tower engineering, overhead line engineering and accessory engineering.

3. The post-evaluation method of power transmission engineering cost according to claim 1, wherein the sub-item cost of the power transmission engineering is divided by unit project, when X represents unit project vector, vector YεR^{m} represents uncertainty factor, each sub-item cost can be expressed as f(X,Y), where, R^{m} represents m-dimensional real number space; the distribution function off(X,Y) is calculated as follows:
assuming that the JPDF of Y is p(Y), the probability of f(X,Y) that does not exceed a given critical value α for a definite X is:
$$ϕ ( X , α ) = {\int }_{f ( X , Y ) \leq α} p ( Y ) dY ;$$
where, X=[X₁, X₂, . . . , Xₙ], n is the number of unit project; φ(X,α) is the distribution function of sub-item cost, a represents a given sub-item cost level.

4. The post-evaluation method of power transmission engineering cost according to claim 3, wherein a distribution curve of the distribution function φ(X,α) of the sub-item cost is obtained based on normal distribution simulation.

5. The post-evaluation method of power transmission engineering cost according to claim 3, wherein a distribution curve of the distribution function φ(X,α) of the sub-item cost is obtained based on historical data simulation.

6. The post-evaluation method of power transmission engineering cost according to claim 4, wherein the corresponding VaR value of each sub-item cost f(X,Y) is represented by α_{β}(X) when the confidence that f(X,Y) does not exceed the critical value α is β, then α_{β}(X) can be represented by the following formula:
α_{β}(X)=min{αεR:φ(X,α)≧β}.

7. The post-evaluation method of power transmission engineering cost according to claim 6, wherein u(X) represents the mean of sub-item costs in φ(X,α) distribution curve, assuming that Xᵢ represents an unit project, the mean of corresponding sub-item costs is represented by u(Xᵢ), the corresponding VaR value under the confidence β is represented by α_{β}(Xᵢ), assuming that θ_{β}(Xᵢ) represents an overall volatility weight of sub-item cost, then θ_{β}(Xᵢ) can be represented by following formula:
θ_{β}(Xᵢ)=α_{β}(Xᵢ)/u(Xᵢ);
where, Xᵢ represents a unit project; i=1, 2, . . . , n, n is the number of unit project;
using the result of overall volatility weight of a sub-item cost under confidence β as a reference, the post-evaluation of the level of risk of sub-item cost for a specific power transmission engineering is performed, assuming that c(Xᵢ) represents a sub-item cost corresponding to a unit project Xi of a particular project; θ(Xᵢ) represents the degree of deviation from the population mean, i.e. deviation coefficient, and θ(Xᵢ) can be represented by the following formula:
θ(Xᵢ)=c(Xᵢ)/u(Xᵢ);
assuming that σ(Xᵢ) represents the risk assessment score of Sub-item cost c(Xᵢ), its value is measured by difference of overall volatility weight θ_{β}(Xᵢ) between θ(Xᵢ) and sub-item cost under confidence β, namely:
σ(Xᵢ)=θ(Xᵢ)−θ(Xᵢ);
where, the smaller σ(Xᵢ) is, the smaller the risk of fluctuations of sub-item cost c(Xᵢ) for the particular project.

8. A risk management and control method of power transmission engineering cost, comprising:
(1) measuring the effect of sub-item cost on total cost using contribution degree index, and determining the unit project that should focus on management and control according to the sequence of contribution degree;
the contribution degree consists of two parts: (a) overall volatility level of all sub-item costs; (b) the proportion of each sub-item cost among total cost; by comprehensively considering the overall volatility level of sub-item cost and the proportion of each sub-item cost among total cost, the contribution degree index is calculated by the following formula:
k(Xᵢ)=kₚ(Xᵢ)×θ_{β}(Xᵢ)
wherein, kₚ(Xᵢ) is the proportion of sub-item cost c(Xᵢ) among total cost; θ_{β}(Xᵢ) represents the overall volatility weight of sub-item cost; i=1, 2, . . . , n, n is the number of unit projects;
(2) screening the main sub-item cost according to the sequence of contribution degree, establishing an optimized stochastic linear programming model of sub-item cost; the cost of design change risk is expressed by the following formula:
c₁=γ₁×y₀
where, c₁ is the cost of design change risk, γ₁ is the rate of design change risk, y₀ is the general cost level; defining that γ₁ is within the range of [γ₁₋, γ₁₊], if exceeding the range, the engineering is feasible; γ₁₋ and γ₁₊ are determined by historical data or experiences;
the cost of duration management risk is expressed by the following formula:
c₂=γ₂×T₀×i_{c}
where, c2 is the cost of duration management risk, γ₂ represents the rate of duration management risk, γ₂=T/T₀, T represents time exceeding the estimated duration, T₀ is the estimated duration, i_{c} is the rate of indirect cost within unit time; defining γ₁ is within the range of [γ₂₋, γ₂₊]; In the span of the construction period, there are uncertainty factor of equipment price changes and changes in labor costs, and the two costs are expressed by the following formula:
c₃=c₃₁×γ₃₁+c₃₂×γ₃₂
where, c31 represents the estimated cost of equipment, γ31 represents the rate of equipment price risk; c₃₂ represents the estimated cost of labor, γ₃₂ represents the rate of labor cost risk; defining γ₃₁ and γ₃₂ are within the range of [γ₃₁₋, γ₃₁₊], [γ₃₂₋, γ₃₂₊] respectively;
based on above work, a stochastic linear programming model can be established to control the cost within a reasonable range of risk:
y_{β-}≦(1+γ₁)×y₀+γ₂×T₀×ic+c₃₁×γ₃₁+c₃₂×γ₃₂≦y_{β+}
γ₁₋≦γ₁≦γ₁₊
γ₂₋≦γ₂≦γ₂₊
γ₃₁₋≦γ₃₁≦γ₃₁₊
γ₃₂₋≦γ₃₂≦γ₃₂₊
assuming that y=(1+γ₁)×y₀+γ₂×T₀×ic+c₃₁×γ₃₁+c₃₂×γ₃₂, the target of the above optimization problem is to control y within the interval [yβ−, yβ+], the solution of optimization model is the risk intervals of γ₁, γ₂, γ₃₁ and γ₃₂, and the above problem is converted to obtain the combination of optimal solutions of γ₁, γ₂, γ₃₁ and γ₃₂ when y is the right boundary y_{β+}; here, the combination of optimal solution refers to the maximum of combination (γ₁, γ₂, γ₃₁, γ₃₂), that is, as long as the risk is controlled within the range of optimal combination, it can ensure that y is within [y_{β—}, y_{β+}]; namely:
max(γ₁,γ₂,γ₃₁,γ₃₂)
(1+γ₁)×y₀+γ₂×T₀×ic+c₃₁×γ₃₁+c₃₂×γ₃₂=y_{β+}
γ₁₋≦γ₁≦γ₁₊
γ₂₋≦γ₂≦γ₂₊
γ₃₁₋≦γ₃₁≦γ₃₁₊
γ₃₂₋≦γ₃₂≦γ₃₂₊
obtaining the combination of optimal solutions of γ₁, γ₂, γ₃₁ and γ₃₂.

9. The risk management and control method of power transmission engineering cost according to claim 8, wherein random variables in the above optimization model are simulated using Monte Carlo method, to obtain a group of optimal solutions based on samples in each group, and for the combination of 50 groups of optimal solutions within the solution domain, the mean of the optimal solutions is used as the optimal solution.

10. The post-evaluation method of power transmission engineering cost according to claim 5, wherein the corresponding VaR value of each sub-item cost f(X,Y) is represented by α_{β}(X) when the confidence that f(X,Y) does not exceed the critical value α is β, then α_{β}(X) can be represented by the following formula:
α_{β}(X)=min{αεR:φ(X,α)≧β}.

11. The post-evaluation method of power transmission engineering cost according to claim 10, wherein u(X) represents the mean of sub-item costs in φ(X,α) distribution curve, assuming that Xᵢ represents an unit project, the mean of corresponding sub-item costs is represented by u(Xᵢ), the corresponding VaR value under the confidence β is represented by α_{β}(Xᵢ), assuming that θ_{β}(Xᵢ) represents an overall volatility weight of sub-item cost, then θ_{β}(Xᵢ) can be represented by following formula:
θ_{β}(Xᵢ)=α_{β}(Xᵢ)/u(Xᵢ)
where, Xᵢ represents a unit project; i=1, 2, . . . , n, n is the number of unit project;
using the result of overall volatility weight of a sub-item cost under confidence β as a reference, the post-evaluation of the level of risk of sub-item cost for a specific power transmission engineering is performed, assuming that c(Xᵢ) represents a sub-item cost corresponding to a unit project Xi of a particular project; θ(Xᵢ) represents the degree of deviation from the population mean, i.e. deviation coefficient, and θ(Xᵢ) can be represented by the following formula:
θ(Xᵢ)=c(Xᵢ)/u(Xᵢ);
assuming that σ(Xᵢ) represents the risk assessment score of Sub-item cost c(Xᵢ), its value is measured by difference of overall volatility weight θ_{β}(Xᵢ) between θ(Xᵢ) and sub-item cost under confidence β, namely:
σ(Xᵢ)=θ(Xᵢ)−θ_{β}(Xᵢ);
where, the smaller σ(Xᵢ) is, the smaller the risk of fluctuations of sub-item cost c(Xᵢ) for the particular project.
